(19) United States
(12) Patent Application Publication
(10) Pub. No.: US 2011/0047599 A1
(43) Pub. Date: Feb. 24, 2011

(54) MICROMINIATURE PERSONAL COMPUTER AND METHOD OF USING THEREOF

(76) Inventors: Wagan Sarukhanov, Moscow (RU); Igor Komov, Moscow (RU); Alexander Podelko, Stamford, CT (US)

Correspondence Address: HESS PATENT LAW FIRM, P.C., 9 MIRAMAR LANE, STAMFORD, CT, 06902, US

(21) Appl. No.: 12/624,724

(22) Filed: Nov. 24, 2009

(30) Foreign Application Priority Data
Aug. 24, 2009 (RU) 2009131804

(51) Int. Cl. G06F 21/00

(52) U.S. Cl. 726/4

(57) ABSTRACT

A microminiature personal computer that is connected to external devices using standard interfaces for information input and output. The microminiature personal computer has an interconnected processor, a memory, a security module, and a connector. At least part of memory should be non-volatile to keep operating system, drivers to work with external devices, programs and data. The microminiature personal computer does all processing and all programs are running inside its memory while external device is used only for information input and output through a virtual window thus ensuring security of both systems and lack of unauthorized interaction between them.

### BACKGROUND OF THE INVENTION

The present invention relates to a microminiature personal computer, i.e., a small form factor general-purpose computer using external devices for information input and output.

In computing, a form factor specifies the physical dimensions of major system components. There were numerous efforts to create small form-factor devices which would be really small and portable and provide functionality of general-purpose computer. It is possible to classify these efforts into several categories.

The largest category is small computers with built-in devices for user information input and output, sometimes referred to as mobile computing (http://en.wikipedia.org/wiki/Mobile_computing). There are many groups of such devices and they are marketed under different names, including pocket personal computer (PC), personal digital assistant (PDA), tablet PC, handheld PC, micro PC, smart phone, ultra-mobile PC.

Including user interface doesn't allow to decrease the size of these devices beyond certain limits due to requirements imposed by human-computer interaction (to be usable, screen and keyboard can't be too small). Small input/output devices often require special software and limit functionality.

Another category are portable computers without user interface, but requiring special hosting devices to be attached to. While there are many inventions claimed (20060253894, U.S. Pat. No. 6,538,880, 20020097555, U.S. Pat. No. 7,533,408, U.S. Pat. No. 5,264,992, U.S. Pat. No. 5,708,840, U.S. Pat. No. 6,029,183, 20090200367), devices embodied such inventions could be expected to use with special hosting devices.

The third large group, sometimes referred to as software mobility or portable platforms (http://en.wikipedia.org/wiki/Comparison_of_portable_platforms), is a technology of storing software and data in a mobile storage medium. When the device is attached to a host computer, these programs may be loaded into the host computer and executed there.

All processing is done by the host computer in this case, so it limits what programs can be run. Security risk is higher because the host computer and the storage device are not isolated.

It would be desirable to implement in small form factor (such as USB-flash form factor) a microminiature personal computer equipped to do all processing so all programs run inside the microminiature personal computer. That way, an external device, to which the microminiature personal computer is connected, is used only for information input and output through a virtual window. As a result, security of both systems is assured because there will be a lack of unauthorized interaction between them.

### SUMMARY OF THE INVENTION

One aspect of the invention relates to a microminiature personal computer, which interconnects a processor, a memory, a security module, and a connector and uses external devices for information input and output. At least part of memory should be non-volatile to keep operating system, drivers to work with external devices, programs and data. Microminiature personal computer does all processing and all programs are running inside its memory while external device is used only for information input and output through a virtual window thus ensuring security of both systems and lack of unauthorized interaction between them.

Another aspect of the invention relates to a method assembling a microminiature personal computer into an operative condition by connecting it to a port of an external device, the microminiature personal computer having an operating system equipped to do all processing so all programs run inside the microminiature personal computer. The external device being used only for information input and output through a virtual window to interface with the operating system of the microminiature personal computer.

A further aspect of the invention resides in a method of use involving running an operating system and programs by a microminiature personal computer connected to an external device, entering information via a user interface of the external device, processing the entered information by the operating system and programs inside the microminiature personal computer and sending results of the processed information to the external device, where it can be sent, for example, to a display, speaker or a network connected device.

The processor speed and memory volume of the microminiature personal computer are sufficient for running office, business and game program under supervision of its Operating System, access to Local Area Network and Internet, playing audio- and video-information.

Desktop or portable computers can be used as external input/output devices, as well as smart phones, personal digital assistants, and multimedia devices such as musical centers and TV sets. Different interfaces can be used to connect to external input/output devices; for example, USB, 1394, LPT, Ethernet, and Bluetooth.

### BRIEF DESCRIPTION OF THE DRAWING

FIG. 1 is a block diagram of the microminiature personal computer attached to an external computer.

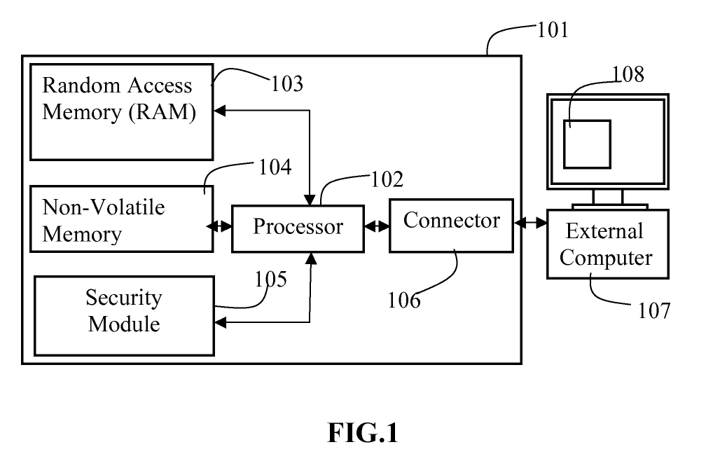

FIG. 2 is a flowchart of the microminiature personal computer.

### DETAILED DESCRIPTION OF THE PREFERRED EMBODIMENT

A microminiature personal computer 101, which could be implemented in USB-flash form factor, comprises an interconnected processor 102, a random access memory 103, a non-volatile memory 104, a security module 105, and a connector 106. The microminiature personal computer 101 can be attached by connector 106 to, for example, an external personal computer 107, which works as an external input/output device.

Non-volatile memory 104 of the microminiature personal computer consists of at least two areas. One area is intended for the Operating System, personal data, and programs, and has an ability to be logically attached to the Operating System of external computer as a virtual storage device. Another area is intended for a virtual windows driver that may be activated on the external computer 107 and create at least one virtual window 108 on the screen of the external computer.

After attaching the microminiature personal computer 101 to the external computer 107 by the connector 106, the processor 102 loads programs under the Operating System supervision from non-volatile memory 104 into RAM 103 and starts them. After virtual windows driver installation, virtual windows 108 is created on the screen of the external personal computer 107, which is used for output of the programs executed by the microminiature personal computer 101. The keyboard, the mouse, and the other devices of the external personal computer 107 are used for information input and output of for the programs executed by the microminiature personal computer 101 and associated with the virtual window 108. Personal data and programs may be encrypted by security module 105.

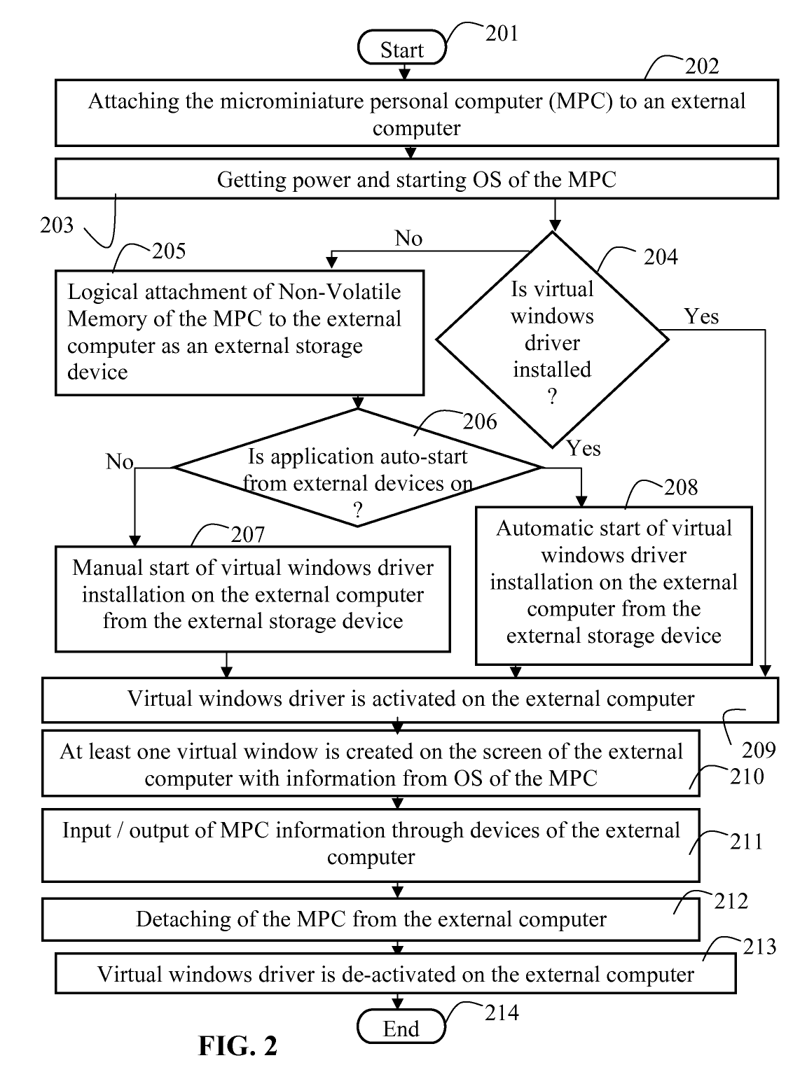

According to the flowchart shown on FIG. 2, the microminiature personal computer 101 is working as following:

Step 201: Start

Step 202: Attaching the microminiature personal computer 101 to the external computer 107

Step 203: Starting the Operating System of the microminiature personal computer 101

Step 204: If the virtual windows driver was installed on the external personal computer 107, go to step 209

Step 205: Logical attachment of the non-volatile memory 104 of the microminiature personal computer 101 to the external computer 107 as an external storage device

Step 206: If the application auto-start from external devices is allowed on the external computer 107, go to step 208

Step 207: Manual start of the virtual windows driver installation on the external computer 107. Go to step 209

Step 208: Automatic start of the virtual windows driver installation on the external computer 107

Step 209: Activating of the virtual windows driver on the external personal computer 107

Step 210: Creating at least one virtual window 108 on the screen of the external personal computer 107 with information from the Operating System of the microminiature personal computer 101

Step 211: Input and output of information from the microminiature personal computer 101 through devices of the external computer 107 while the programs are executed inside the microminiature personal computer 101

Step 212: Detaching the microminiature personal computer 101 from the external computer 107

Step 213: De-activating the virtual windows driver on the external computer 107

Step 214: End

What is claimed is:

1. A microminiature personal computer comprising interconnected a processor, memory, a security module, and a connector, and using external devices for information input and output through a standard interface, where the said microminiature personal computer does all processing while the external device is used only for information input/output through a virtual window thus ensuring security of both systems and lack of unauthorized interaction between them.

2. A method assembling the microminiature personal computer of claim 1 into an operative condition by connecting it to a port of an external device, so all programs run inside the microminiature personal computer and the external computer based device being used only for information input and output through a virtual window.

3. A method of use of the microminiature personal computer of claim 1 involving running an operating system and programs by a microminiature personal computer connected to an external device, entering information via a user interface of the external device, processing the entered information by the operating system and programs inside the microminiature personal computer, and sending results of the processed information to the external device.

4. The microminiature personal computer of claim 1, using a desktop computer for information input and output.

5. The microminiature personal computer of claim 1, using a portable computer for information input and output.

6. The microminiature personal computer of claim 1, using a musical center for information input and output.

7. The microminiature personal computer of claim 1, using a TV set for information input and output.

8. The microminiature personal computer of claim 1, using a home theater for information input and output.

9. The microminiature personal computer of claim 1, using a smart phone for information input and output.

10. The microminiature personal computer of claim 1, using a Personal Digital Assistant for information input and output.

11. The microminiature personal computer of claim 1, using a multifunctional multimedia device for information input and output.

12. The microminiature personal computer of claim 1, using a multifunctional car panel for information input and output.

13. The microminiature personal computer of claim 1, using USB interface to attach to external devices for information input and output.

14. The microminiature personal computer of claim 1, using 1394 interface to attach to external devices for information input and output.

15. The microminiature personal computer of claim 1, using Ethernet interface to attach to external devices for information input and output.

16. The microminiature personal computer of claim 1, using Bluetooth interface to attach to external devices for information input and output.

17. The microminiature personal computer of claim 1, being a part of other device like Smart Phone or Personal Digital Assistant.

18. The microminiature personal computer of claim 1, having other hardware modules expanding its functionality.

19. The microminiature personal computer of claim 1 without security module.

20. The microminiature personal computer of claim 1 identified by the unique number built in the security module.

21. The microminiature personal computer of claim 20 using the unique number to encrypt programs and eliminate a possibility of their illegal copying.
